(19) United States
(12) Patent Application Publication
(10) Pub. No.: US 2020/0268613 A1
(43) Pub. Date: Aug. 27, 2020

(54) MEDICATION HOLDING AND REMINDER SYSTEM

(71) Applicant: Katherine Tyriver, Orlando, FL (US)

(72) Inventor: Katherine Tyriver, Orlando, FL (US)

(21) Appl. No.: 16/281,442

(22) Filed: Feb. 21, 2019

(51) Int. Cl. A61J 7/04

(52) U.S. Cl. CPC A61J 7/04; A61J 2205/30

(57) ABSTRACT

A medication holding and reminder system includes a main body having a dry erase marking front surface that is laminated onto a backboard. A plurality of generally transparent pockets is removably secured along the front surface of the main body via connectors, and each of the pockets includes an opening for receiving medication. The front surface includes a daily, weekly or monthly calendar, and the times for which the medication is to be taken.

### TECHNICAL FIELD

The present invention relates generally to medication scheduling, and more particularly to a medication holder and reminder system.

### BACKGROUND

The statements in this section merely provide background information related to the present disclosure and may not constitute prior art.

As individuals age, the number of medications prescribed for daily use increases. Depending on the overall health of the individual, the frequency to which these medications must be taken also rises. To this end, there are no shortage of commercially available pill boxes that can store and organize daily medications for a user. Unfortunately, these known devices can be difficult for the infirm or elderly to open, and the small size makes it difficult to see which pills have or have not been taken.

Accordingly, it would be beneficial to provide a medication holding and reminder system that can aid individuals with taking their daily medications in a manner that does not suffer from the drawbacks described above.

### SUMMARY OF THE INVENTION

The present invention is directed to a medication holding and reminder system. One embodiment of the present invention can include a main body having a dry erase marking front surface that is laminated onto a backboard. The backboard can include components for suspending the main body from a wall or standing upright.

In one embodiment, a plurality of pockets can be removably secured along the front surface of the main body via connectors. Each of the pockets can include an opening for receiving medication and can be constructed from a generally transparent material. In one embodiment, the front surface can include a daily, weekly or monthly calendar, and the times for which the medication is to be taken can be written by the end user.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a frontal view of the medication holding and reminder system, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawing. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

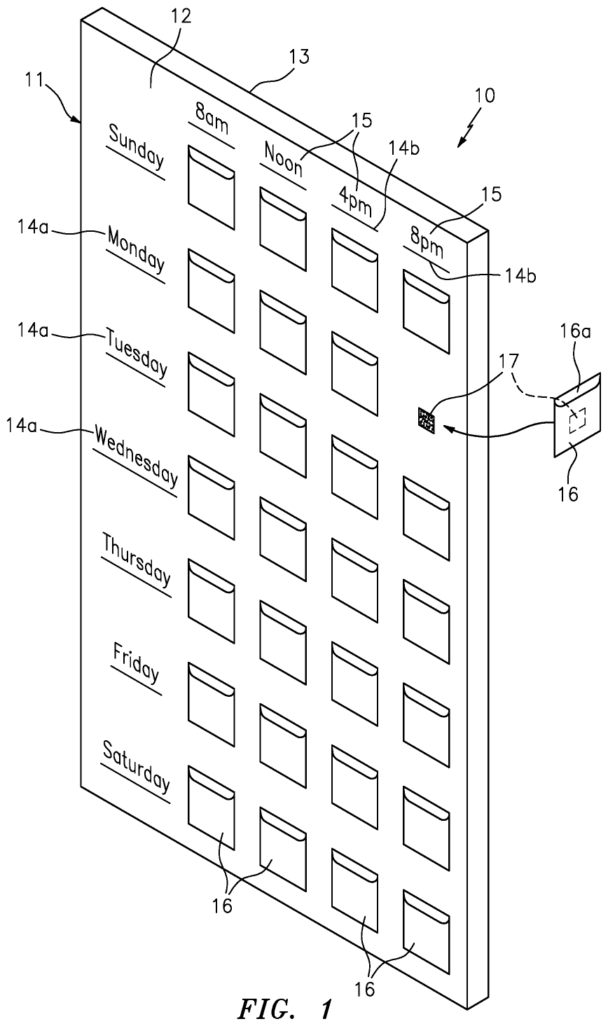

FIG. 1 illustrates one embodiment of a medication holding and reminder system 10 that is useful for understanding the inventive concepts disclosed herein. In the drawing, identical reference numerals are used for like elements of the invention or elements of like function. For the sake of clarity, only those reference numerals are shown in the individual figures which are necessary for the description of the respective figure.

As shown, one embodiment of the system 10 can include, a main body 11 having a plurality of removable medication pockets 16.

As described herein, the main body 11 can be constructed from any number of different materials and can include an unlimited number of different shapes and sizes that are capable of supporting the below described pockets. In the preferred embodiment, the main body 11 can comprise an elongated dry erase marking surface 12 that is laminated onto a correspondingly shaped backboard 13 or another substrate. Although not illustrated, the back surface 13 can include any number of hooks, hangers, or arms, for example, so as to allow the main body to be hung from a wall or stand upright.

As shown, the front surface 12 can include indicia so as to aid a user in organizing their medications. In the preferred embodiment, the indicia can include a one-week calendar listing each day of the week 14a and a series of lines 14b onto which a user/caregiver can use a dry erase marker to write the times 15 they are to take their daily medication.

Although described as including specific indicia, this is for illustrative purposes only, as any number of different versions of the system can be produced having different indicia. For example, the indicia can include a daily, weekly or monthly calendar, having any number of different specified locations for the user/caregiver to write times and/or other information associated with the medication stored in a given pocket is to be taken. In either instance, the indicia may be inked on, etched on or otherwise affixed to the marking surface 12 in accordance with known manufacturing techniques.

As shown, a plurality of transparent pockets 16 each having an opening 16a for receiving medication can be provided with the system. In various embodiments, the pockets can be produced in groups of different colors so as to aid a caregiver in filling multiple pockets at once. For example, each of the pockets to be filled with medication taken at 8 am can be green, whereas each of the pockets to be filled with medication to be taken at noon can be orange, and so forth.

In the illustrated embodiment, twenty-eight medication pockets are provided so as to accommodate users who take medication four times each day of the week. Of course, other embodiments of the system are contemplated wherein a greater or fewer number of pockets are provided. Although illustrated as open-ended pockets, other embodiments are contemplated wherein the pockets include a flap or other such device that can be opened by the end user to access the medication stored inside.

As noted above, each of the pockets 16 can be removably secured to the main body 11, so as to allow a user to remove the pocket containing the medication at the time of consumption. Such a feature provides a clear ongoing visual indicator to the user and/or caregiver of what medications have been taken for each day.

In the preferred embodiment, the pockets can be removably secured to the main body via connectors such as opposing strips of hook and loop material 17, for example. Of course, any number of other connectors are also contemplated. For example, in another embodiment the connectors can comprise magnetic elements which can be permanently positioned along the back side of each pocket, and magnetically attracted to a metallic surface that is positioned between the front surface 12 and back surface 13 of the main body 11.

Although illustrated above as including a pre-configured device having four designated times per day, other embodiments are contemplated. For example, the system can be provided as a kit having the main body, pockets and connectors, along with no permanent markings designating days of the week. In this regard, a user can customize the layout of the pockets to correspond to different needs or uses.

Accordingly, the above described system provides a clear visual indication to a user of when medication must be taken. The pockets provide easy access to the medication by the end user by simply removing the pocket from the main body at the designated time and having the correct pills ready to consume. Moreover, once the pockets have been removed, the board provides a clear visual indication of what medications have been taken for each day.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A medication holding and reminder system, comprising:
a main body having a front end and a back surface,
said front surface including indicia for organizing medications, said indicia including a first column representing a plurality of days, and a plurality of secondary columns each representing a time;
a plurality of pockets that are removably secured along the front surface, each of said plurality of pockets including a color that is specific to one of the secondary columns; and
a plurality of connectors that are disposed between the plurality of pockets and the front surface.

2. The system of claim 1, wherein an entirety of the front surface comprises a dry erase marking surface.

3. The system of claim 2, wherein each of the plurality of pockets are constructed from a transparent material and are configured to receive and store medication in a pill form.

4. The system of claim 1, wherein seven of the plurality of pockets are positioned along each of the secondary columns,
and the pockets for column includes a different color a different color.

5. The system of claim 1, wherein the connectors comprise strips of hook and loop material.

6. (canceled)

7. A medication holding and reminder system, consisting of:
a main body having a front surface and a back surface;
a first column that is disposed along the front surface of the main body representing a plurality of days;
a plurality of secondary columns each representing a time;
a plurality of pockets that are removably secured along the front surface of the main body, each of said plurality of pockets comprising a color that is specific to one of the secondary columns; and
a plurality of connectors that are disposed between the plurality of pockets and the front surface of the main body.

7. A medication holding and reminder system kit, said kit comprising:
a rectangular-shaped dry erase board;
a plurality of transparent pockets, said plurality of transparent pockets including four groups of seven individual pockets, each group including a different color; and
a plurality of connectors that are configured to secure each of the plurality of transparent pockets to a front surface of the dry erase board.
